(19) United States
(12) Patent Application Publication
(10) Pub. No.: US 2014/0032826 A1
(43) Pub. Date: Jan. 30, 2014

(54) METHOD OF TRAINING MEMORY CORE AND MEMORY SYSTEM

(71) Applicant: Samsung Electronics Co., Ltd., Suwon-si (KR)

(72) Inventors: Woo-Jin LEE, Seoul (KR); Dae-Hyun KIM, Hwaseong-si (KR); Seung-Jun BAE, Hwaseong-si (KR); Young-Soo SOHN, Seoul (KR); Tae-Young OH, Seoul (KR)

(21) Appl. No.: 13/941,359

(22) Filed: Jul. 12, 2013

Related U.S. Application Data
(60) Provisional application No. 61/675,601, filed on Jul. 25, 2012.

(30) Foreign Application Priority Data
Mar. 11, 2013 (KR) 10-2013-0025392

(51) Int. Cl. G06F 12/00

(52) U.S. Cl. CPC G06F 12/00
USPC 711/104; 711/154

(57) ABSTRACT

A method of training a memory device included in a memory system is provided. The method includes testing memory core parameters for a memory core of the memory device during a booting-up sequence of the memory system; determining trimmed memory core parameters based on the test results; storing the determined trimmed memory core parameters; and applying the trimmed memory core parameter to the memory device during a normal operation of the memory device.

### CROSS-REFERENCE TO RELATED APPLICATION(S)

This application claims priority under 35 USC §119(e) to and claims the benefit of U.S. Provisional Application No. 61/675,601 filed on Jul. 25, 2012, in the U.S. Patent and Trademarks Office (USPTO) and claims priority under 35 USC §119(a) to Korean Patent Application No. 10-2013-0025392 filed on Mar. 11, 2013, in the Korean Intellectual Property Office (KIPO), the entire contents of which are incorporated by references herein.

### BACKGROUND

This disclosure relates to training memory devices, and more particularly to a method of training a memory core and memory systems.

Dynamic random access memories (DRAMs), have yield issues due to shrunk fabrication processes for accomplishing higher integration rates. For increasing a yielding rate, DRAMs are typically determined as passing or failing through wafer level testing or package level testing.

In various test processes, training is performed for determining optimal operating parameters of the DRAMs and operation margins are set using the optimal operating parameters in normal operation of the DRAMs.

In the conventional DRAM training, parameters for optimizing an interface are controlled by using some portion of a memory core between a start address and end address. This may occur after system integration of a DRAM. However, in current system, memory core training does not occur after system integration.

### SUMMARY

Some exemplary embodiments provide a method of training a memory core capable of adjusting memory core parameters.

Some exemplary embodiments provide a memory system capable of adjusting memory core parameters.

According to some exemplary embodiments, a method of training a memory device included in a memory system is provided. The method includes testing memory core parameters for a memory core of the memory device during a booting-up sequence of the memory system; determining trimmed memory core parameters based on the test results; storing the determined trimmed memory core parameters; and applying the trimmed memory core parameter to the memory device during a normal operation of the memory device.

According to some exemplary embodiments, a memory system includes a memory device including a memory cell array and a memory controller that controls the memory device. The memory device is configured to perform training on the memory cell array during booting-up the memory system by testing parameters associated with the memory cell array, determine trimmed parameters based on the test results, and store the determined trimmed parameters in a parameter register. The memory system is configured to apply the trimmed parameters to the memory device during a normal operation of the memory device.

According to some exemplary embodiments, a method of operating a mobile computing system including a memory device is provided. The method includes training an input/output (I/O) interface of the memory device; training a memory core to determine and set parameters of the memory core included in the memory device; and performing a normal operation of the memory device included in the mobile computing system based on the results of the input/output (I/O) interface training and the memory core training.

### BRIEF DESCRIPTION OF THE DRAWINGS

Exemplary embodiments will be more clearly understood from the following detailed description taken in conjunction with the accompanying drawings.

FIG. 1 is a block diagram illustrating a memory system according to an exemplary embodiment.

FIG. 2 is a flow chart illustrating a method of training a memory device in FIG. 1 according to some exemplary embodiments.

FIG. 3 is a flow chart illustrating a step of training a memory core in FIG. 2 according to some exemplary embodiments.

FIG. 4 is a flow chart illustrating a step of testing memory core parameters in FIG. 3 according to some exemplary embodiments.

FIG. 5 is a block diagram illustrating a computing system according to some exemplary embodiments.

### DETAILED DESCRIPTION OF THE EMBODIMENTS

Various exemplary embodiments will be described more fully hereinafter with reference to the accompanying drawings, in which some exemplary embodiments are shown.

The invention may, however, be embodied in many different forms and should not be construed as limited to the exemplary embodiments set forth herein. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. Unless indicated otherwise, these terms are used to distinguish one element from another. Thus, a first element discussed below could be termed a second element without departing from the teachings of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms such as “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

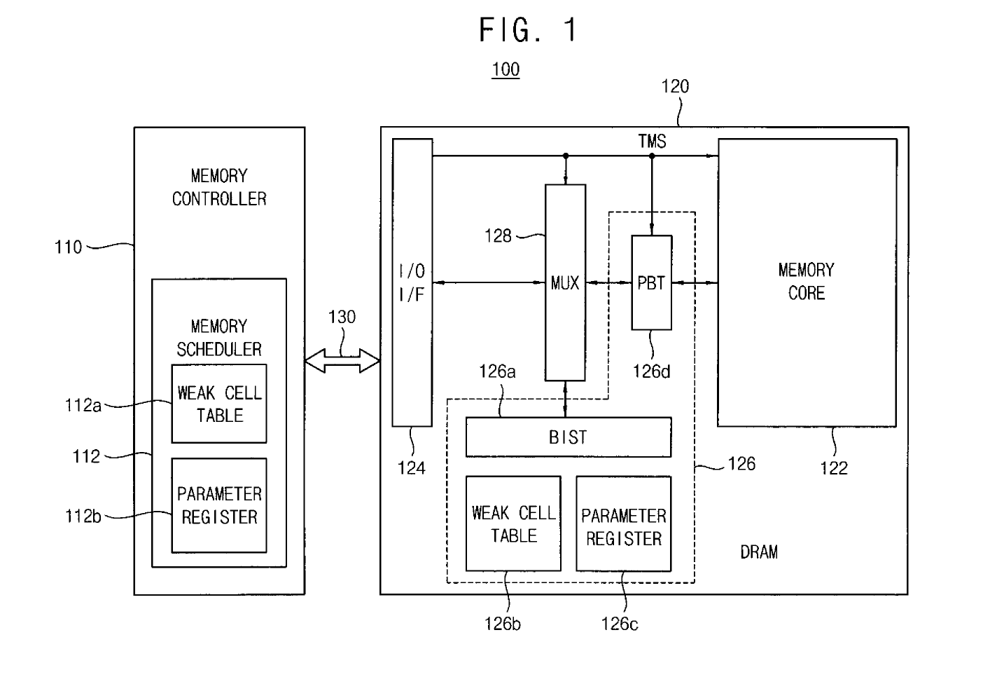

FIG. 1 is a block diagram illustrating a memory system according to an exemplary embodiment.

Referring to FIG. 1, a memory system 100 may include a memory controller 110 and a memory device 120. The memory controller 110 and the memory device 120 are connected to each other via an input/output (I/O) bus 130. In one embodiment, the memory device 120 may be a single memory chip or a memory module including a plurality of memory devices.

In some exemplary embodiments, the memory device 120 and/or the memory controller 110 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

The memory system 100 of FIG. 1 may be employed in a computing system such as a mobile system and a desktop computer.

The memory controller 100 includes a memory scheduler 112 which controls the memory device 120 according to operating characteristics of the memory device 120. The memory scheduler 112 may perform I/O interface training of the memory device 120 and a memory core parameter training of the memory device 120 during a booting-up sequence of the memory system 100. The memory scheduler 112 may include a weak cell table 112a and a parameter register 112b. In one embodiment, the weak cell table 112a may store weak cell information designating weak cells of the memory device 120, which are detected at a package level test by an automatic test equipment (ATE) and the memory scheduler 112 may perform the memory core parameter training just on the weak cells designated by the weak cell information stored in the weak cell table 112a. The parameter register 112b may store trimmed core parameters that are determined based on a result of the memory core training.

In one embodiment, the memory device 120 may be implemented with a DRAM, and the memory device 120 may include a memory core 122 and a peripheral circuitry. The memory core 122 may include, for example, memory cell arrays, a row decoder and a column decoder. The peripheral circuitry may include, for example, an I/O interface 124, a multiplexer 128 and a test control circuit 126. The memory core 122 operates in one of a normal operation mode and a test operation mode in response to a test mode signal TMS. The test mode signal TMS may be generated based on test mode control signals respectively generated in the memory controller 110 and/or the test control circuit 126. The multiplexer 128 may multiplex address signals, data signals and control signals in response to the test mode signal TMS indicating one of an internal test mode, an external test mode and a normal operation mode.

In one embodiment, the I/O interface 124 may include an address buffer that buffers the address signal provided from I/O pads, a data I/O buffer and a control logic that decodes the control signals.

The test control circuit 126 may include a built-in self test (BIST) circuit 126a, a weak cell table 126b, a parameter register 126c and a parallel bit test (PBT) circuit 126d.

The parameter register 126c may be an extended mode set register (EMRS) or may be a non-volatile memory device such as a flash memory device, EEPROM and EPROM.

The PBT circuit 126d is enabled or disabled in response to the test mode signal TMS. When the PBT circuit 126d is enabled, the PBT circuit 126d gradually compares bit pairs of data that are read from the memory cell arrays in parallel and thus may reduce bit numbers of test result data.

The memory system 100 may selectively perform one of the internal test mode and the external test mode when testing the memory core parameters.

In the internal test mode, the BIST circuit 126a performs memory core parameter training. In the internal test mode, the BIST circuit 126a and the memory core 122 are connected to each other via the multiplexer 128.

In the external test mode, the memory controller 110 performs the memory core parameter training. In the external test mode, the I/O interface 124 and the memory core 122 are connected to each other via the multiplexer 128.

In addition, the memory device 120 may selectively perform one of a weak cell test mode and a PBT mode for reducing time required for training when performing the memory core parameter training.

In the weak cell test mode, the memory core parameter training is performed on only weak cells in the memory core 122, and not on all cells in the memory core 122, and trimmed operating parameters are determined based on analysis of results of training of the weak cells. In the weak cell test mode, the PBT circuit 126d is disabled and the memory core 122 is directly connected to the multiplexer 128.

In the PBT mode, the memory core parameter training is performed on all of the cells in the memory core 122, and trimmed operating parameters are determined based on analysis of results of training of all cells. In the PBT mode, the PBT circuit 126d is enabled and the memory core 122 is connected to the multiplexer 128 through comparators in the PBT circuit 126d.

In an exemplary embodiment, a test control circuit 126 only performing the weak cell test mode may not include the PBT circuit 126d. In another exemplary embodiment, a test control circuit 126 only performing the PBT mode may not include the weak cell table 126b.

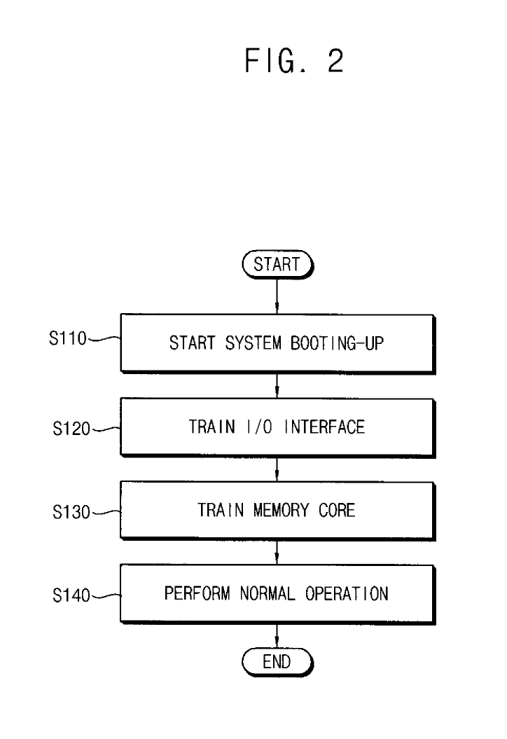

FIG. 2 is a flow chart illustrating a method of training a memory device in FIG. 1 according to some exemplary embodiments.

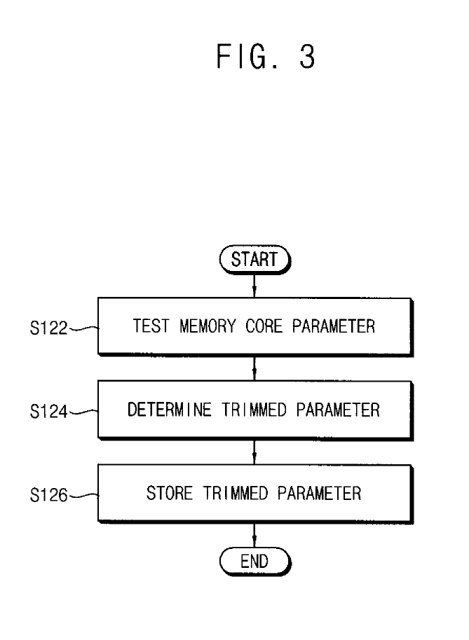

FIG. 3 is a flow chart illustrating a step of training a memory core in FIG. 2 according to some exemplary embodiments.

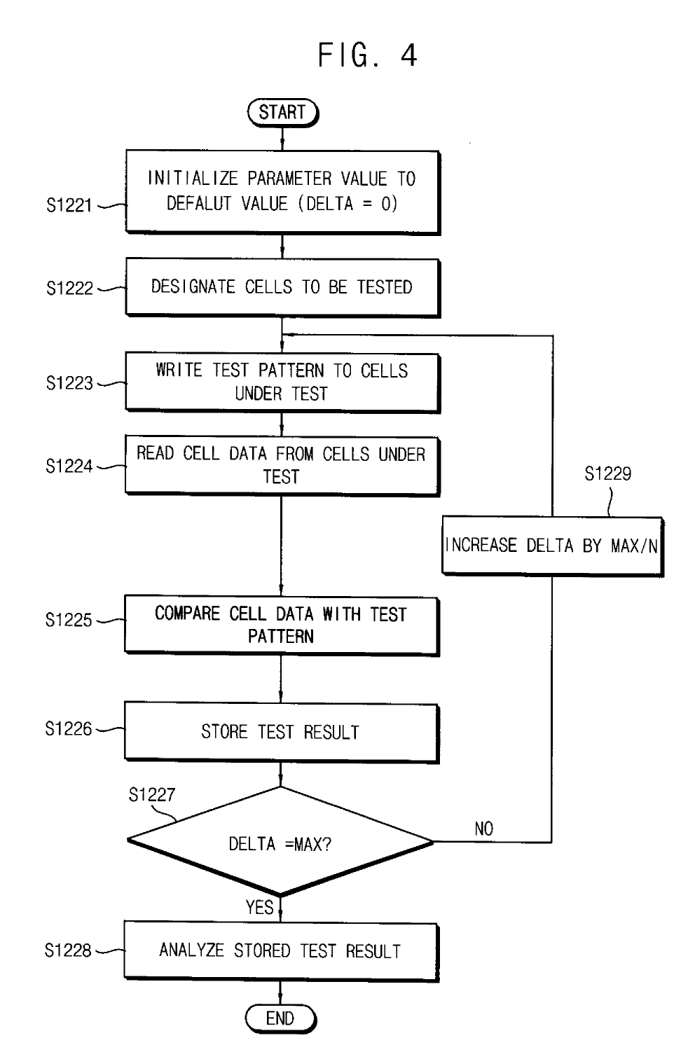

FIG. 4 is a flow chart illustrating a step of testing memory core parameters in FIG. 3 according to some exemplary embodiments.

Referring to FIG. 2, in a method of training a memory device, when a power is applied to a system including a memory controller and a memory device, booting-up sequence is started (S110). When the system is in the booting-up sequence, I/O interface training is performed (S120). The I/O interface training may include at least one of address training, a clock training, a write training and a read training. After the I/O interface training is performed, memory core training is performed (S130). After the memory core training is performed, normal operation of the memory device is performed (S140).

In some exemplary embodiments, memory device training is performed during the booting-up sequence after a power is applied to the memory system 100.

Referring to FIG. 3, for training the memory core, memory core parameters are tested during the booting-up sequence (S122). Trimmed memory core parameters are determined based on the test results (S124). The determined trimmed memory core parameters are stored for applying the trimmed memory core parameter to the memory device 120 during a normal operation of the memory device (S126).

Referring to FIG. 4, for testing the memory core parameters, values of the memory core parameters are initialized to default values by the BIST circuit 126a in the internal test mode during the booting-up sequence (S1221). In addition, delta, i.e., increment variable, is set to “0”. Memory cells to be tested are designated (S1222). In the weak cell test mode, the PBT circuit 126d is disabled in response to the test mode signal TMS having a first logic level, i.e., a logic low level. Weak cell addresses designating the weak cells are provided to the row decoder and the column decoder in the memory core through the multiplexer 128. The BIST circuit 126a generates test pattern data and the test pattern data is written to the weak cells (or all memory cells in the memory core) to be tested (S1223). Data are read from the weak cells (or all memory cells in the memory core) under test (S1124). Read data are compared with the test pattern data in the BIST circuit 126a (S1125). A test result is stored in the BIST circuit 126a based on the comparison result (S1226). When the read data matches with the test pattern data, the test result may represent “pass”. When the read data does not match with the test pattern data, the test result may represent “fail”. It is determined whether the delta, i.e., increment variable comes to a predetermined maximum value MAX (S1227). When the delta does not come to the predetermined maximum value MAX (NO), the delta is increased to a value corresponding to MAX/n (S1229), and the process returns to the step (S1223). The steps (S1123˜1227) are repeated until the delta comes to the predetermined maximum value MAX. When the delta comes to the predetermined maximum value MAX (YES), the stored test result is analyzed (S1228).

In the PBT mode, the PBT circuit 126d is enabled in response to the test mode signal TMS having a second logic level, i.e., a logic high level. The BIST circuit 126a generates test pattern data by operating an internal address counter and the test pattern data is written to all memory cells of the memory core (S1223). Data are simultaneously read from all of the cells in parallel (S1124)). Read data simultaneously read from all of the cells in parallel are compared in bit pairs in the PBT circuit 126d to generate reduced read data. The reduced read data are compared with the test pattern data in the BIST circuit 126a (S1125) and stored (S1226). The BIST circuit 126a may vary the value of the memory core parameters in an operating range from the default values (S1227) and the BIST circuit 126a may analyze the stored test results using a memory core parameter analysis algorithm (S1228). The BIST circuit 126a may determine trimmed memory core parameters during the booting-up sequence. Therefore, the memory system 100 may update the memory core parameters to the trimmed memory core parameters.

In one embodiment, the BIST circuit 126a may store the trimmed memory core parameters in the parameter register 126c based on the analyzed test result. Therefore, in a normal operation mode after the memory core training is completed, data are written or read to/from the memory core 122 in an environment set to the trimmed memory core parameters. Therefore, errors that may occur may be minimized in the memory system 100 and thus, operation credibility and endurance of the memory device 120 may be increased.

In an exemplary embodiment, the memory core parameters may include direct current (DC) parameters and alternating current (AC) parameters. The DC parameters may include, for example, operating voltage VINTA of a memory cell array included in the memory core or a bitline voltage VBL. The AC parameters may include, for example, a row address strobe to column address strobe delay time (tRCD) or a write recovery time (tWR). In addition, in certain embodiments, the memory core parameters may include various other parameters. Also, the memory core parameters may be updated to trimmed memory core parameters during each booting-up sequence of the memory system 100.

In the external test mode, the memory controller 110 or a built-off self test (BOST) circuit may perform the memory core parameter training to update the memory core parameters during a booting-up sequence of the memory system 100.

In one embodiment, the memory scheduler 112 in the memory controller 110 may perform the memory core parameter training.

For example, in one embodiment, the memory scheduler 112 issues a command to initialize the values of the memory core parameters during the booting-up sequence of the memory system 100. In response to the command, the memory device 120 initializes the values of the memory core parameters to the default values. The memory scheduler 112 may generate weak cell addresses to the memory device 120 by referring to the weak cell table 112a. The memory scheduler 112 transmits sequentially test pattern data, a write command, and a read command to the memory device 120. The memory device 120 writes the pattern data to weak cells designated by the weak cell addresses, reads data from the weak cells, and transmits the read data to the memory controller 110. The memory scheduler 112 compares the read data with the test pattern data and determines each of the weak cells as passing or failing based on the comparison result.

The memory scheduler 112 may vary the value of the memory core parameters in an operating range from the default values and the memory scheduler 112 may analyze the stored test results using memory core parameter analysis algorithm. The memory scheduler 112 may store the trimmed memory core parameters in the parameter register 112b or in the parameter register 126c. Therefore, the memory system 100 may update the memory core parameters to the trimmed memory core parameters in real time.

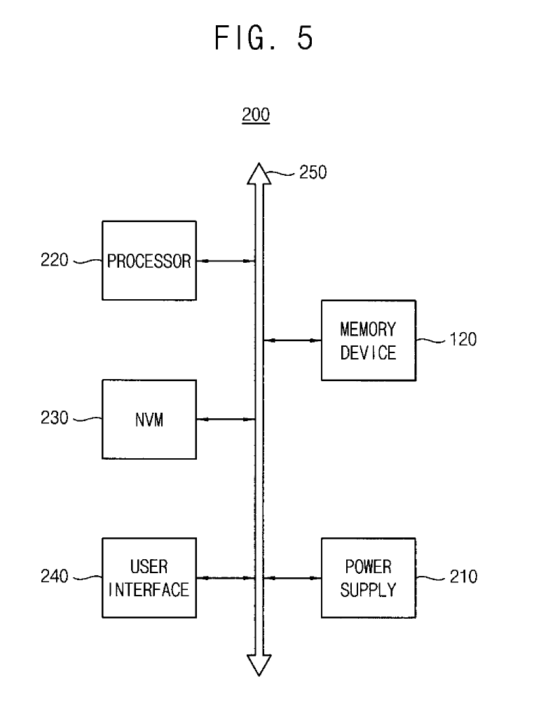

FIG. 5 is a block diagram illustrating a computing system according to some exemplary embodiments.

Referring to FIG. 5, a computing system 500 includes a processor 220, the memory device 120, a nonvolatile memory device 230, a user interface 240 and a power supply 210 that are connected to each other via a system bus 250. In some embodiments, the computing system 200 may be a personal computer (PC), a server computer, a workstation, a mobile computing system such as a laptop computer, a mobile phone, a smart phone, or a personal digital assistant (PDA), a portable multimedia player (PMP), a digital camera, a digital television, a set-top box, a music player, a portable game console, a navigation system, etc.

The processor 220 may perform various computing functions, such as executing specific software for performing specific calculations or tasks. For example, the processor 220 may be a microprocessor, a central process unit (CPU), a digital signal processor, or the like. In some embodiments, the processor 220 may include a single core or multiple cores. For example, the processor 220 may be a multi-core processor, such as a dual-core processor, a quad-core processor, a hexa-core processor, etc. Although FIG. 5 illustrates the computing system 200 including one processor 220, in some embodiments, the computing system 200 may include a plurality of processors. The processor 220 may include an internal or external cache memory.

The memory device 120 may store data processed by the processor 220, or may operate as a working memory. For example, the memory device 220 may be a dynamic random access memory, such as DDR SDRAM, LPDDR SDRAM, GDDR SDRAM, RDRAM, etc.

The nonvolatile memory device 230 may store a boot image for booting the computing system 200. For example, the nonvolatile memory device 230 may be an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The user interface 240 may include at least one input device, such as a keypad, a touch screen, etc., and at least one output device, such as a speaker, a display device, etc. The power supply 210 may supply a power supply voltage to the computing system 200. In some embodiments, the computing system 200 may further include a camera image processor (CIS), and/or a storage device, such as a memory card, a solid state drive (SSD), a hard disk drive (HDD), a CD-ROM, etc.

In some embodiments, the computing system 200 and/or components of the computing system 200 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

As described above, performance of the memory device may be enhanced by performing memory core parameter training during the booting-up sequence of the memory system and updating the trimmed (optimal) memory core parameters in real time.

The disclosed embodiments may be applied to any system including the memory system. The disclosed embodiments may be applied, for example, to a personal computer (PC), a server computer, a workstation, a laptop computer, a mobile phone, a smart phone, a personal digital assistant (PDA), a portable multimedia player (PMP), a digital camera, a digital television, a set-top box, a music player, a portable game console, a navigation system, etc.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present disclosure. Accordingly, all such modifications are intended to be included within the scope of the present inventive concept as defined in the claims.

What is claimed is:

1. A method of training a memory device included in a memory system, the method comprising:
testing memory core parameters for a memory core of the memory device during a booting-up sequence of the memory system;
determining trimmed memory core parameters based on the test results;
storing the determined trimmed memory core parameters; and
applying the trimmed memory core parameters to the memory device during a normal operation of the memory device.

2. The method of claim 1, wherein testing the memory core parameters comprises:
initializing values of the memory core parameters to default values during the booting-up sequence of the memory system; and
storing the test result of the memory parameters by varying the values of the memory core parameters from the default values.

3. The method of claim 1, wherein testing the memory core parameters is performed on weak cells included in the memory core.

4. The method of claim 3, wherein the weak cells are designated by weak cell information stored in a weak cell table included in the memory device.

5. The method of claim 1, wherein testing the memory core parameters is performed on all memory cells included in the memory core in a parallel bit test mode.

6. The method of claim 1, wherein the memory core parameters include direct current (DC) parameters or alternating current (AC) parameters.

7. The method of claim 6, wherein the DC parameters include operating voltage of a memory cell array included in the memory core or a bitline operating voltage.

8. The method of claim 6, wherein the AC parameters include a row address strobe to column address strobe delay time (tRCD) or a write recovery time (tWR).

9. The method of claim 1, further comprising:
training an input/output (I/O) interface of the memory device during the booting-up sequence of the memory system before testing the memory core parameters.

10. The method of claim 1, wherein testing the memory core parameters is performed by using one of the memory controller and a built-in self test (BIST) circuit included in the memory device.

11. The method of claim 1, wherein the determined trimmed memory core parameters are stored in one of the memory controller and a parameter register included in the memory device.

12. The method of claim 1, wherein the memory system is a mobile computing system.

13. A memory system comprising:
a memory device including a memory cell array; and
a memory controller configured to control the memory device,
wherein the memory device is configured to:
perform training on the memory cell array during booting-up the memory system by testing parameters associated with the memory cell array;
determine trimmed parameters based on the test results; and
store the determined trimmed parameters in a parameter register,
wherein the memory system is configured to apply the trimmed parameters to the memory device during a normal operation of the memory device.

14. The memory system of claim 13, wherein the memory device includes a static random access memory (SRAM) and a test control circuit including the parameter register, and
wherein the test control circuit is configured to perform the training on weak cells in the memory cell array based on weak cell information stored in the SRAM and is configured to store the trimmed parameters in the parameter register based on the training result.

15. The memory system of claim 13, wherein the memory device includes a test control circuit including the parameter register, and
wherein the test control circuit is configured to perform the training on all cells included in the memory cell array in a parallel bit test mode and is configured to store the trimmed parameters in the parameter register based on the training result.

16. A method of operating a mobile computing system including a memory device, the method comprising:
training an input/output (I/O) interface of the memory device;
training a memory core to determine and set parameters of the memory core included in the memory device; and
performing a normal operation of the memory device included in the mobile computing system based on the results of the input/output (I/O) interface training and the memory core training.

17. The method of claim 16, wherein training the input/output (I/O) interface and training the memory core are performed during a booting-up sequence of the mobile computing system.

18. The method of claim 17, wherein the memory core training comprises:
testing memory core parameters for the memory core during the booting-up sequence of the mobile computing system;
determining trimmed memory core parameters based on the test results;
storing the determined trimmed memory core parameters; and
applying the trimmed memory core parameters to the memory device during a normal operation of the memory device.

19. The method of claim 18, wherein testing the memory core parameters is performed on weak cells included in the memory core.

20. The method of claim 18, wherein testing the memory core parameters is performed on all cells included in the memory core in a parallel bit test mode.
